(19) United States
(12) Patent Application Publication
(10) Pub. No.: US 2026/0303770 A1
(43) Pub. Date: Oct. 1, 2026

(54) METHOD FOR REDUCING DEPTH CONFLICTS IN STEREOSCOPIC DISPLAYS

(71) Applicant: GOOGLE LLC, Mountain View, CA (US)

(72) Inventor: Philip George Nichols Lamoureux, San Francisco, CA (US)

(21) Appl. No.: 19/479,650

(22) PCT Filed: Jun. 9, 2023
(86) PCT No.: PCT/US2023/068187

§ 371 Date: Oct. 28, 2025

(51) Int. Cl. H04N 13/128; H04N 13/361; H04N 13/366

(52) U.S. Cl. CPC H04N 13/128; H04N 13/361; H04N 13/366

(57) ABSTRACT

A depth conflict between objects displayed on a stereoscopic display occurs when a background object is rendered at a first depth that is smaller than a second depth of a foreground object overlaid on the background object. This conflict can be resolved by making the first depth of the background object larger while the foreground object is overlaid on the background object. After the overlapping condition concludes, the first depth of the background object may be returned to its original value.

### FIELD OF THE DISCLOSURE

The present disclosure relates to stereoscopic displays and more specifically to a method for adjusting displayed content presented on a virtual reality (VR) system.

### BACKGROUND

A VR system may include a head-mounted device (HMD) configured to display scenes in three-dimensions (3D). The VR system may further include sensors to detect the head movements of a user and adjust the scenes displayed accordingly so that the user may have an immersive experience. The 3D perception can be based on a parallax effect generated by transmitting stereoscopic images to a left eye and a right eye of the user. In some implementations, multiple applications may simultaneously display content on the HMD, each content generating a different parallax effect.

### SUMMARY

Overlapping images displayed on a stereoscopic display may generate a depth-convergence conflict (i.e., depth conflict) when the overlapping depth cue is opposite to the depth cue provided by the parallax effect. The present disclosure describes systems and methods to prevent this depth conflict by adjusting (i.e., pushing back) the stereoscopic depth of the bottom image of the overlapping pair of images. The adjustment may be large enough that the depth conflict can be resolved even when a precise stereoscopic depth of the top image of the overlapping pair of images is unknown.

In some aspects, the techniques described herein relate to a method for preventing a depth conflict on a stereoscopic display, the method including: receiving an interpupillary distance; adjusting the interpupillary distance to generate an adjusted interpupillary distance; providing the adjusted interpupillary distance to a first application to render first stereoscopic images at an adjusted stereoscopic depth based on the adjusted interpupillary distance; providing the interpupillary distance to a second application to render second stereoscopic images at a second stereoscopic depth based on the interpupillary distance; and displaying the second stereoscopic images as overlapping the first stereoscopic images on the stereoscopic display, the second stereoscopic depth being less than the adjusted stereoscopic depth.

A proposed method for preventing a depth conflict on a stereoscopic display, may thus comprise receiving at least one interpupillary distance value for rendering of a stereoscopic image the at least one interpupillary distance value being indicative for an interpupillary distance of a user; adjusting the at least one interpupillary distance value to generate at least one adjusted interpupillary distance value; providing the at least one adjusted interpupillary distance value to a first application to render first stereoscopic images at an adjusted stereoscopic depth based on the at least one adjusted interpupillary distance value (e.g., using the at least one adjusted interpupillary distance value for rendering the first stereoscopic images at the adjusted stereoscopic depth); providing the at least one interpupillary distance value to a second application to render second stereoscopic images at a second stereoscopic depth based on the at least one interpupillary distance; and displaying, to the user, the second stereoscopic images as overlapping the first stereoscopic images on the stereoscopic display, wherein adjusting the at least one interpupillary distance value to generate at least one adjusted interpupillary distance value comprises adjusting the at least one interpupillary distance value so that the adjusted stereoscopic depth to be used for rendering the stereoscopic images is greater than the second stereoscopic depth to prevent a depth conflict on the stereoscopic display when displaying the first and second images.

In one embodiment, the second stereoscopic depth being less than the adjusted stereoscopic depth prevents an overlap of the second stereoscopic images on the first stereoscopic images from creating the depth conflict for a user.

In one embodiment, the adjusted interpupillary distance is less than the interpupillary distance. Accordingly, an adjusted interpupillary distance value used for rendering the first images at the adjusted stereoscopic distance may be less than an least one interpupillary distance value that is indicative for the (actual) interpupillary distance of a user to which the first and second images are displayed and that is used for rendering the second images at the second stereoscopic depth.

In one embodiment, the adjusted interpupillary distance is zero and the adjusted stereoscopic depth is infinity. This may thus include that the at least one (all if there are more than one) adjusted interpupillary distance value may be zero so that the adjusted stereoscopic depth becomes infinity.

In one embodiment, adjusting the interpupillary distance includes gradually reducing the interpupillary distance to the adjusted interpupillary distance over a period so that the first application is configured to render the first stereoscopic images at a depth that gradually increases over the period from a first stereoscopic depth to the adjusted stereoscopic depth. In such an embodiment, at least one received interpupillary distance value may be adjusted by gradually reducing the at least one interpupillary distance value to the at least one adjusted interpupillary distance value over a period of time so that the first application is configured to render the first stereoscopic images at a depth that gradually increases over the period of time from a first stereoscopic depth to the adjusted stereoscopic depth.

In one embodiment, the first application is configured to use the interpupillary distance to render the first stereoscopic images at a first stereoscopic depth while the second application does not render the second stereoscopic images; and use the adjusted interpupillary distance to render the first stereoscopic images at the adjusted stereoscopic depth while the second application renders the second stereoscopic images. In such an embodiment, the first application may thus for example be configured to use at least one received interpupillary distance value to render the first stereoscopic images at a first stereoscopic depth while the second application does not render the second stereoscopic images; and use the at least one adjusted interpupillary distance value to render the first stereoscopic images at the adjusted stereoscopic depth while the second application renders the second stereoscopic images. Generally, the adjusted stereoscopic depth may be greater than the first stereoscopic depth for preventing the depth conflict when displaying the first and second stereoscopic images.

In one embodiment, adjusting the interpupillary distance to generate the adjusted interpupillary distance includes multiplying the interpupillary distance by a scale factor. Such scale factor may, for example, be in a range between zero and one, i.e. for a scale factor X: 0<X<1.

In one embodiment, the proposed method may further comprise receiving a head-translation; adjusting the head-translation to generate an adjusted head-translation; and providing the adjusted head-translation to the first application to render the first stereoscopic images to have an adjusted motion-parallax based on the adjusted head-translation while the first stereoscopic images are rendered at the adjusted stereoscopic depth. For example, in such an embodiment, the proposed method may thus further comprise receiving at least one head-translation value indicative for the translation of a head of the user for which the interpupillary distance was received (the translation of the head of the user relating to movement and orientation of the head of the user with respect to a reference point and/or reference coordinate system); adjusting the at least one head-translation value to generate at least one adjusted head-translation value; and providing the at least one adjusted head-translation value to the first application to render the first stereoscopic images using the at least one adjusted head-translation value for determining an adjusted motion-parallax while the first stereoscopic images are rendered at the adjusted stereoscopic depth.

In one embodiment, adjusting the interpupillary distance to generate the adjusted interpupillary distance includes multiplying the interpupillary distance by a factor, e.g., the above mentioned scale factor; and adjusting the head-translation to generate the adjusted head-translation includes multiplying the head-translation by the factor. For example, such an embodiment may thus comprise adjusting the at least one received interpupillary distance value to generate the at least one adjusted interpupillary distance valued includes multiplying the at least one interpupillary distance value by a factor, e.g., the above mentioned scale factor; and adjusting the at least one head-translation value to generate the at least one adjusted head-translation value may include multiplying the head-translation by the (same) factor.

In some aspects, the proposed solution and thus techniques described herein also relate to a head-mounted device comprising a stereoscopic display configured to display first and second stereoscopic images; and a processor coupled to the stereoscopic display, the processor configured to perform an embodiment of the proposed method.

In some aspects, the proposed solution and thus techniques described herein also relate to a head-mounted device including: a stereoscopic display configured to display stereoscopic images; a memory configured to store head-mounted device parameters; and a processor coupled to the stereoscopic display and the memory, the processor configured by software instructions to: provide the head-mounted device parameters to a first application running on the processor, the first application configured to render a scene at a first stereoscopic depth based on the head-mounted device parameters; and adjust the head-mounted device parameters provided to the first application to increase the first stereoscopic depth of the scene to an adjusted stereoscopic depth while a second application, running on the processor, renders a window at a second stereoscopic depth based on the head-mounted device parameters, the window overlapping the scene on the stereoscopic display.

A proposed head-mounted device may thus include a stereoscopic display configured to display stereoscopic images; a memory configured to store head-mounted device parameters; and a processor coupled to the stereoscopic display and the memory, the processor configured by software instructions to: provide the head-mounted device parameters to a first application running on the processor, the first application configured to render a scene with first stereoscopic images at a first stereoscopic depth using the head-mounted device parameters; and adjust the head-mounted device parameters provided to the first application to increase the first stereoscopic depth of the scene to an adjusted stereoscopic depth while a second application, running on the processor, renders a window with at least one second stereoscopic image at a second stereoscopic depth based on the head-mounted device parameters, the window overlapping the scene on the stereoscopic display. The second stereoscopic depth may be less than the adjusted stereoscopic depth to prevent the window overlapping the scene on the stereoscopic display from creating a depth conflict for a user of the head-mounted device.

In one embodiment head-mounted device the head-mounted device parameters includes an interpupillary distance. Accordingly, the head mounted device parameters may include at least one interpupillary distance that is indicative for an interpupillary distance of the user of the head-mounted device to which the window overlapping the scene is displayed.

In one embodiment, the interpupillary distance is reduced to an adjusted interpupillary distance to increase the first stereoscopic depth of the scene to the adjusted stereoscopic depth. For example, the at least one interpupillary distance value may be reduced to at least one adjusted interpupillary distance value to increase the first stereoscopic depth of the scene to the adjusted stereoscopic depth.

In one embodiment the interpupillary distance is reduced to the adjusted interpupillary distance over a period. For example, the at least one interpupillary distance value may thus be reduced to the at least one adjusted interpupillary distance value over a period of time.

In one embodiment, the adjusted interpupillary distance is zero and the adjusted stereoscopic depth is infinity. Accordingly, the at least one adjusted interpupillary distance value may be zero so that the adjusted stereoscopic depth becomes infinity.

In one embodiment, the head-mounted device parameters includes a head-translation. In such an embodiment, the head-mounted device parameters may thus include a head-translation value indicative for the translation of a head of the user of the head-mounted device (the translation of the head of the user relating to movement and orientation of the head of the user with respect to a reference point and/or reference coordinate system).

In one embodiment, the head-translation is reduced to an adjusted head translation to decrease a motion-parallax of the scene. In such an embodiment, the at least one head-translation value may thus for example be reduced to an adjusted head-translation value to decrease a motion-parallax of the scene.

In one embodiment, the head-mounted device is a virtual reality system. The proposed solution thus also relates to a virtual reality system comprising at least one embodiment of a proposed head-mounted device configured to display, at the stereoscopic display and to a user of the head-mounted device, a virtual environment including the first and second stereoscopic images or the window overlapping the scene.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a block diagram of a head-mounted device according to a possible implementation of the present disclosure.

FIG. 2 is a stereoscopic display from a perspective of a user according to a possible implementation of the present disclosure.

FIGS. 3A-3B illustrate stereoscopic views for different interpupillary distances according to possible implementation of the present disclosure.

FIG. 4 illustrates motion-parallax for a head translation according to a possible implementation of the present disclosure.

FIG. 5 illustrates a block diagram of a head-mounted device according to a possible implementation of the present disclosure.

FIG. 6 is a graph of rendering parameters adjusted over time according to a possible implementation of the present disclosure.

FIG. 7 is a graph showing the stereoscopic depth adjustment according to a possible implementation of the present disclosure.

FIG. 8 is a method for preventing a depth conflict on a stereoscopic display according to an implementation of the present disclosure.

FIG. 9 is a stereoscopic display from a perspective of a user illustrating a scrim applied to a window according to a possible implementation of the present disclosure.

FIG. 10 is a stereoscopic display from a perspective of a user illustrating an overlay applied to a user interface according to a possible implementation of the present disclosure.

The components in the drawings are not necessarily to scale relative to each other. Like reference numerals designate corresponding parts throughout the several views.

### DETAILED DESCRIPTION

Some of the strongest depth cues for human depth perception may result from the brain's interpretation of the position (i.e., convergence) and focus (i.e., accommodation) of the eyes when viewing a scene. These depth cues may be lost when the scene is rendered as images on a screen. Despite this, other depth cues may be used to help a user perceive depth from the images. For example, images of the scene may be rendered to include (monocular) depth cues, from overlap and motion-parallax. Additionally, images of the scene may be rendered to include (binocular) depth cues from a stereoscopic-effect. These depth cues may enhance a user's perception that the images displayed are three-dimensional (3D), which can create a more immersive experience in a virtual reality (VR) environment.

Stereoscopic images include a left image of a scene for display to the left eye of a user and the right image of the scene for display to a right eye of a user. The scene in the left and right images may be shifted in perspective so that it appears to the left and right eye of a user as originating from a scene at a stereoscopic depth from the user.

In a system (e.g., VR system) running multiple applications, each application may render stereoscopic images for display at different stereoscopic depths. For example, a first application (e.g., running on the VR system) may render first stereoscopic images at a first stereoscopic depth, while a second application (e.g., simultaneously running on the VR system) may render second stereoscopic images at a second stereoscopic depth. Each application may select the stereoscopic depth for rendering independently, which may result in depth perception problems when the stereoscopic depths are not equal.

In some instances, it may be desirable to simultaneously display the second stereoscopic images as overlapping the first stereoscopic images. The overlap provides a visual depth cue that the second stereoscopic depth is less than (i.e., closer to the user) than the first stereoscopic depth. A depth conflict occurs when, despite overlapping, the second stereoscopic depth is larger (i.e., further from the user) than the first stereoscopic depth. A depth-convergence conflict (i.e., depth conflict) can cause discomfort (e.g., eye strain, nausea, etc.) to a user. Accordingly, it may be desirable to prevent, reduce, or eliminate the depth conflict. The present disclosure describes a system and method for preventing a depth conflict on a stereoscopic display, such as used in a head-mounted device.

The disclosed approach can prevent the depth conflict by adjusting the relative stereoscopic depths to agree (i.e. align) with the depth cues provided by the overlap. One advantage of the disclosed approach is that the adjustment does not require determining the first stereoscopic depth and/or the second stereoscopic depth thereby reducing computational complexity, which may have the technical advantage of reducing power consumed by the process and increasing the speed of the process, as compared to other approaches. As a result, the disclosed approach is well suited for head-mounted devices, such as a VR headset.

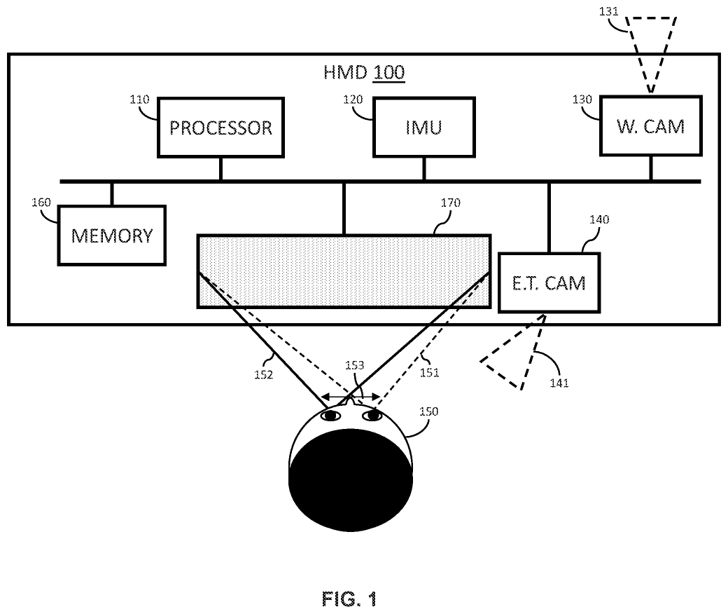

FIG. 1 is a block diagram of a head-mounted device (HMD 100) according to a possible implementation of the present disclosure. In a possible implementation, the HMD 100 is a virtual reality headset worn by a user 150 for viewing VR content (e.g., game). The HMD 100 can include one or more position sensors. For example, the HMD 100 can include an inertial measurement unit (IMU 120) configured to detect and measure a movement and an orientation of the HMD 100, which when worn by the user 150 can correspond to a movement/orientation of the user's head (e.g., a head-translation). The HMD 100 may further include a world camera 130 having a field-of-view 131 directed to an environment of the user. Images from the world camera 130 can be captured and processed to determine movements (e.g., a head-translation) of the user's head. The HMD 100 may further include at least one eye-tracking camera (e.g., eye-tracking camera 140) having a field-of-view 141 directed towards an eye of the user 150. Images from the eye-tracking camera 140 can be captured and processed to determine position and movements of the user's eye(s) in order to track the user's eye(s). The user's eyes may be directed at a stereoscopic display 170. As a result, eye tracking, based on images from the eye-tracking camera 140, can be used to locate where the user is looking (e.g., focus point) on the stereoscopic display 170.

The stereoscopic display 170 of the HMD 100 may be configured to present light differently for each eye of a user. For example, a right view 151 of a right eye of the user 150 may receive light corresponding to a right image of a stereoscopic image and a left view 152 of a left eye of the user 150 may receive light corresponding to a left image of the stereoscopic image. The right view 151 and the left view 152 may be separated by an interpupillary distance 153. The interpupillary distance (IPD) may be sensed by a device, set by a user, and/or factory set prior to use. For example, the IPD may be an average IPD of possible users of the HMD 100 (e.g., 60 millimeters (mm)) stored in a memory 160 of the HMD 100 as a parameter used for rendering the stereoscopic images (i.e., as a rendering parameter).

The HMD 100 may further include at least one processor (e.g., a processor 110). The processor 110 may be communicatively coupled to the devices described thus far. The processor may be configured by software instructions (e.g., recalled from the memory 160) to run applications for the head-mounted device. For example, the applications may include a first application that the user is interacting with and a second application also running and rendering. For example, the first application may be an application (e.g., game) run by a user and the second application may be an application run by the system (e.g., notification application). Each application may use the stereoscopic display 170 to display information to the user. In the example above, the second application (e.g., notification application) may display information only when necessary, while the first application (e.g., game) may display information continuously, while in use by the user. The first application and the second application are independent. For example, the first application and the second application may be provided from different developers. The first application and the second application may be independently launched (i.e., started at different times). In an possible implementation, The first application and the second application may or may not be distinct from an operating system of the device. For example, the first application and the second application may run on an application layer above the operating system.

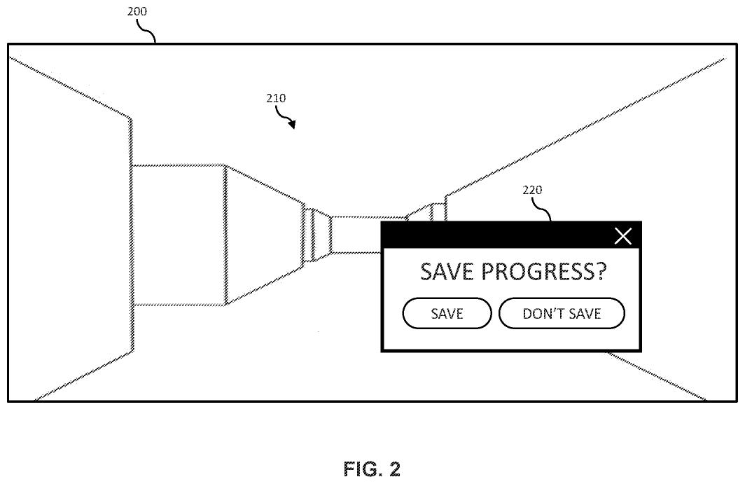

FIG. 2 is a stereoscopic display from a perspective of a user according to a possible implementation of the present disclosure. The stereoscopic display 200 is configured to display a stereoscopic image or a stream of stereoscopic images (e.g., video stream). The stereoscopic images may be rendered for display by one or more applications. The stereoscopic images rendered by the one or more applications may be displayed at the same time (e.g., as overlapping windows). As shown in FIG. 2, a first stereoscopic image 210, corresponding to a scene (e.g., from a game), is displayed on the stereoscopic display 200. At the same time, a second stereoscopic image 220, corresponding to a window (e.g., from an operating system), is displayed on the stereoscopic display 200. The second stereoscopic image 220 is displayed as a smaller stereoscopic image that overlaps a portion of the first stereoscopic image 210 (i.e., overlap condition). In other words, a frame of VR content (e.g., VR objects) may include two stereoscopic images that overlap. To prevent the overlap condition (i.e., overlap) from creating a depth conflict for a user (i.e., viewer), the stereoscopic depth of the second stereoscopic image 220 (i.e., window) should be less than (i.e., closer to the user) than the stereoscopic depth of the first stereoscopic image 210 (i.e., scene).

The stereoscopic images shown in FIG. 2 are but one possible implementation having a depth conflict. For example, any time two (or more) stereoscopic images (or VR objects) are displayed simultaneously on portions of the stereoscopic display, the individually rendered stereoscopic depths may create discomfort if they result in a depth cue that conflicts with another depth que. Further, a difference between the stereoscopic depths of two (or more) stereoscopic images may create discomfort when presented as being the at the same depth (e.g., side-by-side).

In nature, the difference between the left eye's view and the right eye's view for a closer object is larger than the difference between the left eye's view and the right eye's view for a farther object. An object placed at a depth of infinity (e.g., ≥1000·IPD) may result in no apparent difference between the left eye's view of the object and the right eye's view of the object. Accordingly, the brain may interpret an object's depth by the degree that the views of the object from each eye differ.

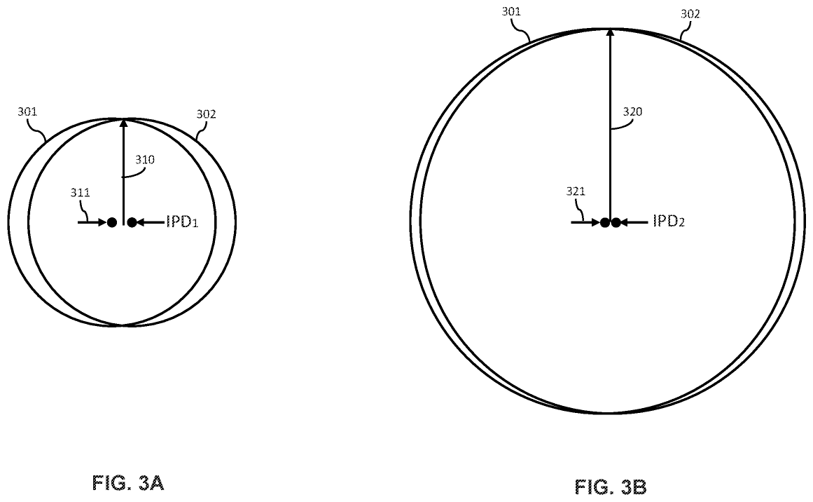

FIGS. 3A and 3B illustrate how the stereoscopic depth of a rendered stereoscopic image can be adjusted. In FIG. 3A, a left view 301 and a right view 302 are separated by a first interpupillary distance 311 (IPD₁). The brain can interpret the first degree of overlap between the left view 301 and the right view 302 as corresponding to a first stereoscopic depth 310. In FIG. 3B, the left view 301 and the right view 302 are separated by a second interpupillary distance 321 (IPD₂). The second interpupillary distance 321 is smaller than the first interpupillary distance 311. Accordingly, a second degree of overlap is greater than a first degree of overlap. The brain can interpret the second degree of overlap between the left view 301 and the right view 302 as corresponding to a second stereoscopic depth 320 that is larger than the first stereoscopic depth. Complete overlap between the left view 301 and the right view 302 would result in an interpupillary distance of zero. The brain can interpret this complete degree of overlap as an infinite stereoscopic depth.

An interpupillary distance and a stereoscopic depth can be used to render a left view and a right view to provide an amount of parallax to objects in the stereoscopic image. Changing the interpupillary distance between the left view and the right view can adjust the amount of parallax of objects in the scene, which may be perceived as a change in the stereoscopic depth perceived by a user. Obviously, the adjustment of the IPD used for rendering does not adjust the user's actual IPD, but the adjustment will change the user's depth perception of the stereoscopic image.

The degree of overlap (or degree of difference) between the views of each eye corresponds to a parallax depth cue. The parallax depth cue is binocular because it requires both eyes. A head mounted device may be further configured to provide monocular depth cues, such as motion-parallax.

In nature, items may move differently in a user's field of view based on where a user is looking as the user's head moves. Accordingly, the brain may interpret an object's depth by how they move in response to a head movement (i.e., head translation).

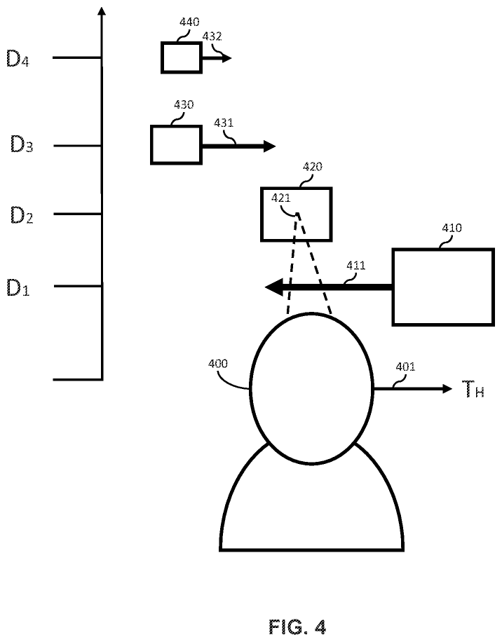

FIG. 4 illustrates motion-parallax for a head translation according to a possible implementation of the present disclosure. As shown, a user 400 is positioned to observe four objects at four increasing depths (i.e., D₁<D₂<D₃<D₄). The relative motion of the objects in the user's field of view are shown, in response to a head-translation 401. The first object 410 is closest and moves according to a first movement 411. The second object 420 is further than the first object and does not move because the user's eyes are focused on the second object 420. The third object 430 is further than the second object and moves according to a third movement 431. The fourth object 440 is further than the third object and moves according to a fourth movement 432. The user may perceive the depth of the objects by the direction and degree of the movement (shown as the size of the arrow) of the objects in response to the user's head translation (T_{H}). For example closer objects may move more than further objects. Objects at a depth greater than a point of focus (i.e., focal point 421) may move in a direction aligned with the head translation, while objects at a depth less than the focal point 421 may move in a direction opposite to the head translation.

A user's head position may change over time and this can be tracked as a changing head translation. The head translation (T_{H}) can be used to render an image sequence having motion-parallax. The head-translation (i.e., actual head-translation of the user) can be reduced to an adjusted head translation (i.e., virtual head-translation of the user) to decrease a motion-parallax of a scene. Obviously, the adjustment of the head translation used for rendering does not adjust the user's actual head translation, but the adjustment will change the user's perception of movement due to motion-parallax. In other words, by changing the translation of a “virtual head” or a rendered viewpoint in the virtual (rendered) scene relative to the user's actual (real) head translation can be performed to adjust (decrease) a motion-parallax of objects in a scene.

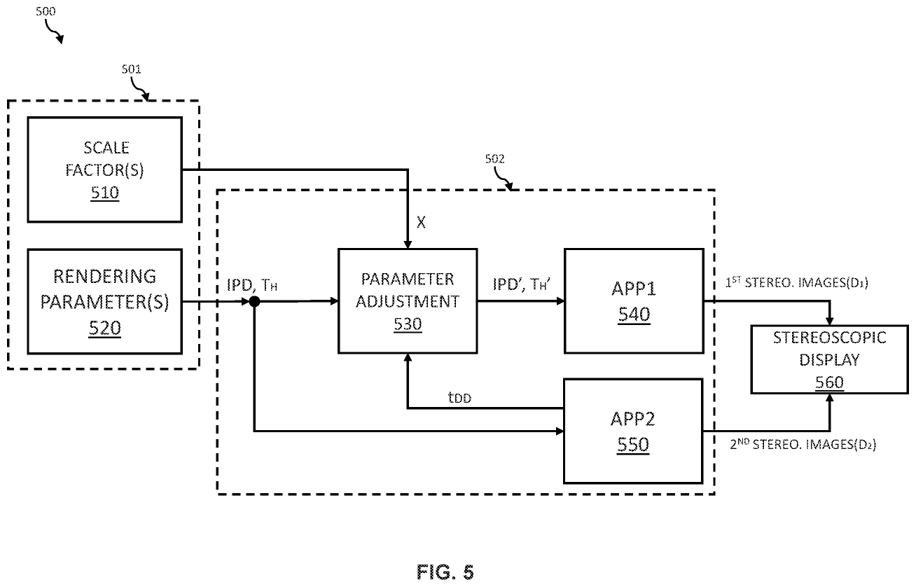

FIG. 5 illustrates a block diagram of a head-mounted device according to a possible implementation of the present disclosure. The head-mounted device (HMD 500) includes a memory 501 that can be configured to store one or more rendering parameters 520, including (but not limited to) an inter pupillary distance (IPD) and a head translation (T_{H}). The parameters may be used to render stereoscopic images to provide the depth cues described previously.

The HMD 500 can further include a processor 502. The processor 502 can be mechanically integrated with the head-mounted device or otherwise communicatively coupled to the HMD 500. In either case, the processor 502 may be configured by software instructions (e.g., recalled from the memory 501) to run multiple applications. As shown, the processor 502 may be configured to run a first application 540 (APP1) and a second application 550 (APP2).

The HMD 500 can further include a stereoscopic display 560 and the applications (APP1, APP2) may each be configured to render stereoscopic images for display on the stereoscopic display 560. In some cases the applications may render stereoscopic images simultaneously. When the stereoscopic images are displayed simultaneously, the images may overlap.

The first application 540 may be configured to render first stereoscopic images (e.g., of a scene) at a first stereoscopic depth (D₁), the second application 550 may be configured to render second stereoscopic images (e.g., of a window) at a second stereoscopic depth (D₂). In order to prevent D1 and D2 from creating a depth conflict when the stereoscopic images overlap, the processor 502 may be further configured to adjust the rendering parameters (e.g., IPD and/or T_{H}) used by one or more of the applications.

The HMD 500 may include a parameter adjustment module to prevent a depth conflict on the stereoscopic display. For example, the parameter adjustment module 530 can be triggered, by a trigger signal (t_{DD}) from the second application 550, to adjust the parameters for rendering while the second application 550 transmits an overlapping stereoscopic image to the stereoscopic display 560. The parameter adjustment module 530 may be configured to adjust the IPD (IPD) to generate an adjusted interpupillary distance (IPD′), and in a possible implementation, the parameter adjustment module may be further configured to adjust the head-translation (T_{H}) to generate an adjusted head-translation (T_{H}′).

Adjusting the IPD may include multiplying the IPD by a scale factor 510 (X) (i.e., IPD′=X·IPD). Adjusting the TH may include multiplying the T_{H} by the scale factor (i.e., T_{H}′=X·T_{H}). The scale factor 510 (X) may be set (e.g., by a user, by one or more of the apps, as a result of an analysis of the images) and stored in the memory 501 for recall by the parameter adjustment module 530. The scale factor 510 (X) may be understood as the inverse of a scale depth multiplier (D) (i.e., X=1/D). For example, if D=2.0 the first stereoscopic depth can be increased (i.e., pushed out) by a factor of 2. The scale factor (X) may be in a range between zero and one (i.e., 0≤X≤1). When X=0 and D=infinity, the first stereoscopic depth has been increased to a maximum limit.

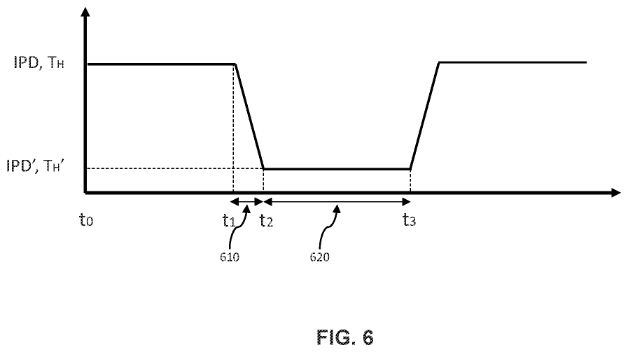

FIG. 6 is a graph of rendering parameters adjusted over time according to a possible implementation of the present disclosure. The rendering parameters shown are an (unadjusted) interpupillary distance (IPD), an (unadjusted) head translation (T_{H}), an adjusted IPD (IPD′) and an adjusted head translation (T_{H}′) as output by a parameter adjustment module 530 of a HMD 500. As shown in the graph, at an initial time (t₀) the display is in a non-overlap condition so the rendering parameters are in an unadjusted state, which may correspond to the physical IPD and T_{H} of a user. At a first time (t₁), an overlapping display condition (i.e.,. overlap condition) is detected. In response, the rendering parameters are adjusted. For example, the IPD can be reduced so that an adjusted stereoscopic depth may be greater than an unadjusted stereoscopic depth.

The adjustment from the (unadjusted) parameter (e.g., IPD) to the adjusted rendering parameter (e.g., IPD′) may occur gradually to allow a user to adapt without noticing the change. For example, the IPD may be reduced to the IPD′ over a first period 610 between the first time (t₁) and a second time (t₂). The reduction of the IPD may increase the stereoscopic depth from an (unadjusted) stereoscopic depth to an adjusted stereoscopic depth. The gradual reduction may result in the first stereoscopic images to gradually increase over the first period 610 from a first stereoscopic depth to an adjusted stereoscopic depth (i.e., adjusted stereoscopic depth>first stereoscopic depth). In practice, the scaling factor (X) can be adjusted over time to adjust both the IPD and a virtual head motion (translation) scaling.

The adjusted rendering parameters may be used by an application (first application) for a second period 620 until, at a third time (t₃), the overlap condition is ended (e.g., the window in FIG. 2 is closed). After the overlap condition has ended, the adjusted parameters may be gradually returned to their original (i.e., default, unadjusted) values. The adjustment period can be repeated as needed over time. The gradual adjustment may include linear interpolation. The adjustment may be applied to different applications as the running applications change. Further, which application receives adjusted rendering parameters may change depending on how things are displayed on the stereoscopic display.

Returning to FIG. 5, in a non-overlap condition the parameter adjustment module 530 may be configured to output unadjusted rendering parameters (i.e., X=1) so that the first application 540 renders stereoscopic images at a first stereoscopic distance. In an overlap condition (i.e., as indicated by signal (t_{DD})), the parameter adjustment module 530 may be configured to output adjusted rendering parameters (i.e., X<1) so that the first application 540 renders first stereoscopic images at an adjusted stereoscopic depth. In other words the depth of the images displayed for the first application are moved away from the user while the depth of the images displayed for the second application remain unchanged (i.e., unadjusted). It may be advantageous to move the images from the first application further away from the user to prevent a depth conflict due to the overlap rather than moving the images from the second application closer towards the user.

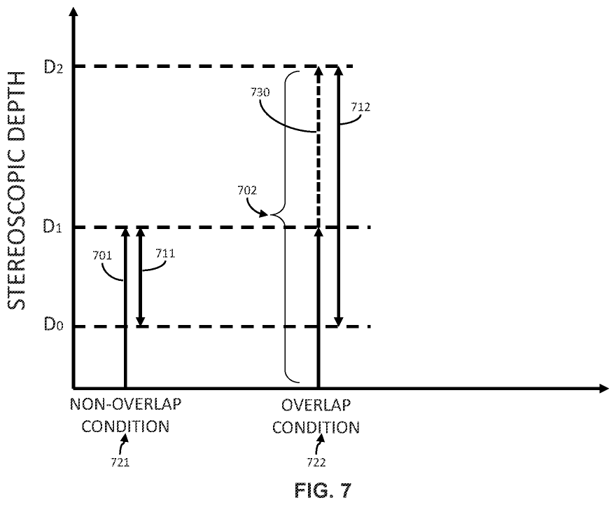

FIG. 7 is a graph showing the stereoscopic depth adjustment according to a possible implementation of the present disclosure. A vertical axis illustrates increasing stereoscopic depth from zero (at the user). In a non-overlap condition 721, the first stereoscopic images (e.g., see FIGS. 2, 210) from the first app (e.g., a scene) are rendered at a first stereoscopic depth 701 (D₁). To prevent a depth conflict, second stereoscopic images (e.g., see FIGS. 2, 220) from the second app (i.e.,, window) must be rendered at a second depth that is within a first (unadjusted) depth range 711 between a minimum depth (D₀) and the first stereoscopic depth 701 (D1).

The minimum depth (D₀) can correspond to a minimum depth for a user to easily focus on an image. In other words, stereoscopic images rendered at a depth less than the minimum depth (D₀) may cause viewing problems (e.g., double vision, eye strain, etc.) for the user.

In an overlap condition 722, the first stereoscopic depth 701 (D₁) is increased by an amount 730 to an adjusted stereoscopic depth 702 (D₂). To prevent a depth conflict, the second stereoscopic images (e.g., see FIGS. 2, 220) from the second app (i.e.,, window) must be rendered in an adjusted depth range 712 between the minimum depth (D₀) and the adjusted stereoscopic depth 702 (D₂). The adjusted depth range 712 is greater than the depth range 711 making it more accommodating for an (unknown) second stereoscopic depth. The minimum depth (D₀) and the amount 730 of adjustment are parameters that can be factory set or adjusted (e.g., based on use).

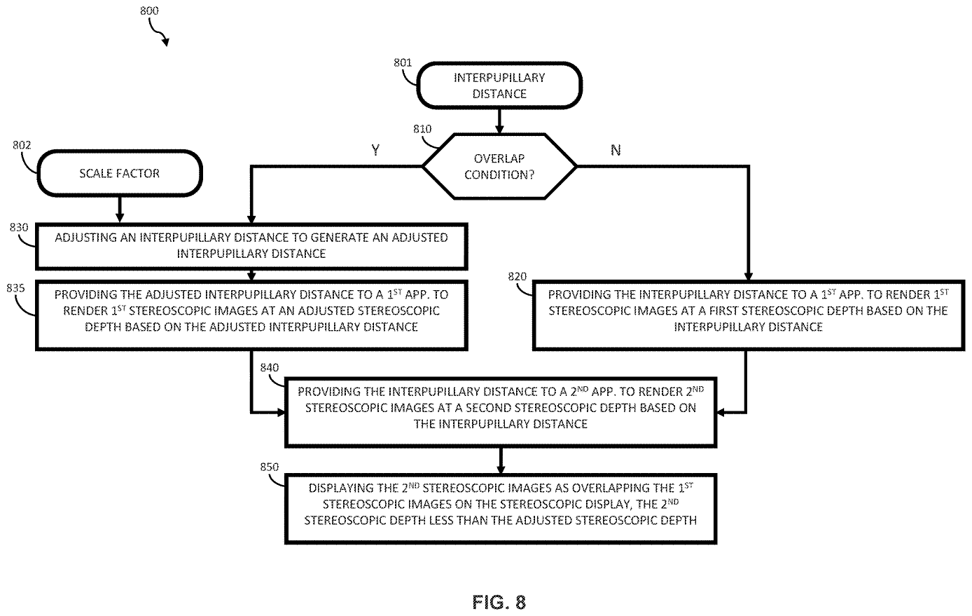

FIG. 8 is a method for preventing a depth conflict on a stereoscopic display according to an implementation of the present disclosure. The method 800 includes receiving an interpupillary distance 801 and determining an overlap condition 810. Note, a similar method can be conceived for a head translation adjustment to prevent a depth conflict, in which the method 800 includes receiving a head translation and proceeds with the adjustment of the head translation.

While an overlap condition exists, the method 800 includes adjusting 830 an interpupillary distance to generate (i.e., based on a scale factor 802) an adjusted interpupillary distance (e.g., smaller interpupillary distance), and providing 835 the adjusted interpupillary distance to a first application so that the first application can render first stereoscopic images at an adjusted stereoscopic depth based on the adjusted interpupillary distance.

While no overlap condition exists, the method 800 includes providing 820 the (unadjusted) interpupillary distance to a first application so that the first application can render first stereoscopic images at a first stereoscopic depth based on the interpupillary distance.

In either condition, after the first stereoscopic images are rendered, the method 800 includes providing 840 the interpupillary distance to a second application so that the second application can render second stereoscopic images and a second stereoscopic depth based on the interpupillary distance.

The method further includes displaying 850 the second stereoscopic images as overlapping the first stereoscopic images on the stereoscopic display. A depth conflict is avoided because the second stereoscopic depth is less than the adjusted stereoscopic depth.

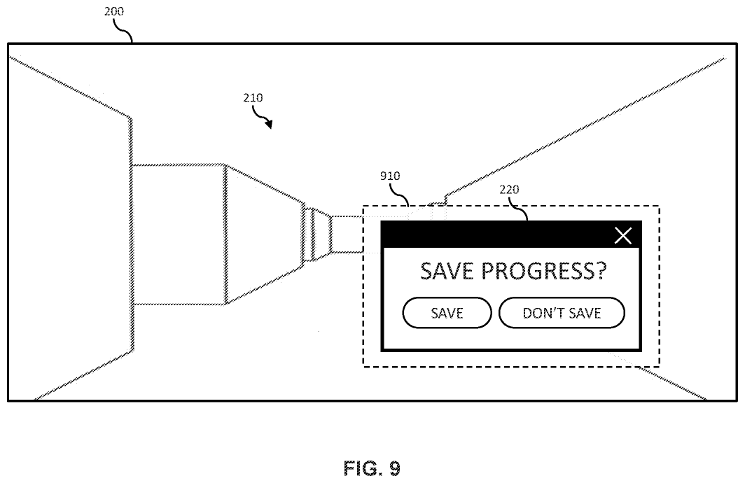

The depth conflict can be eliminated and reduced in other ways that can be combined with, supplement, or replace the stereoscopic depth adjustment described thus far. FIG. 9 is a stereoscopic display from a perspective of a user illustrating a scrim applied to a window according to a possible implementation of the present disclosure. As shown in FIG. 9, the first stereoscopic image 210, corresponding to a scene (e.g., from a game), is displayed on the stereoscopic display 200. At the same time, the second stereoscopic image 220, corresponding to a window (e.g., from an operating system), is displayed on the stereoscopic display 200. The second stereoscopic image 220 is displayed as overlapping the first stereoscopic image 210 (i.e., overlap condition). To further reduce a depth conflict for a user (i.e., viewer), a blurred (i.e., feathered, translucent) border 910 (i.e., scrim) may be added around the second stereoscopic image 220 to help a user see the second stereoscopic image 220 distinctly.

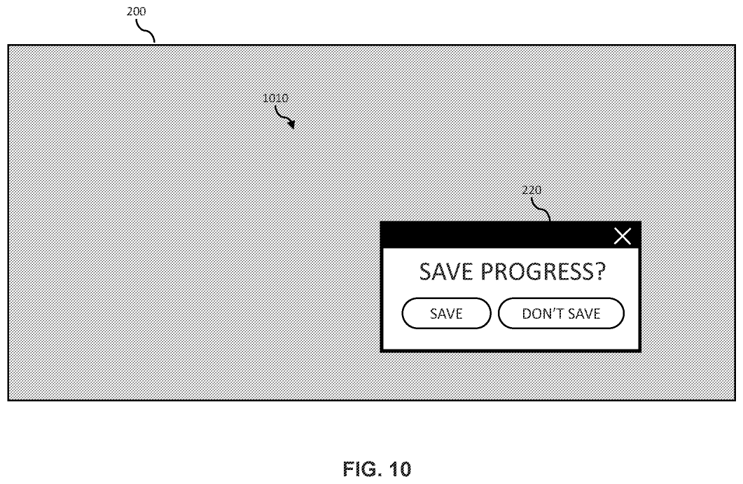

FIG. 10 is a stereoscopic display from a perspective of a user illustrating an overlay applied to a user interface according to a possible implementation of the present disclosure. As shown in FIG. 10, the first stereoscopic image 210, corresponding to a scene (e.g., from a game), is displayed on the stereoscopic display 200 is turned OFF or covered by a monotone image 1010 to eliminate the depth conflict.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

1. A method, the method comprising:
providing a first interpupillary distance to a first application to render first stereoscopic images at a first stereoscopic depth based on the first interpupillary distance;
providing a second interpupillary distance to a second application to render second stereoscopic images at a second stereoscopic depth based on the second interpupillary distance;
displaying the second stereoscopic images and the first stereoscopic images on a stereoscopic display, the second stereoscopic depth being less than the first stereoscopic depth; and
providing a head-translation to the first application to render the first stereoscopic images to have a motion-parallax adjusted based on the head-translation while the first stereoscopic images are rendered at the first stereoscopic depth.

2. The method according to claim 1, wherein providing the first interpupillary distance is triggered by the second application rendering the second stereoscopic images overlapping the first stereoscopic images.

3. The method according to claim 1, wherein the first interpupillary distance makes the first stereoscopic depth larger than the second stereoscopic depth.

4. The method according to claim 1, wherein the first interpupillary distance is zero and the first stereoscopic depth is infinity.

5. The method according to claim 1, further comprising:
gradually reducing the first interpupillary distance over a period so that the first application is configured to render the first stereoscopic images at a depth that gradually increases over the period.

6. The method according to claim 1, wherein the first application is configured to:
provide the first interpupillary distance to the first application to render the first stereoscopic images at the first stereoscopic depth when the second stereoscopic images overlap the first stereoscopic images.

7. The method according to claim 6, wherein the first stereoscopic depth is provided to prevent a depth conflict caused by the overlap.

8. The method according to claim 6, further comprising:
multiplying an initial interpupillary distance by a scale factor (X) to generate the first interpupillary distance.

9. The method according to claim 8, wherein the scale factor (X) is in a range between zero and one (0<X<1).

10. (canceled)

11. The method according to claim 8, further comprising:
multiplying an initial head-translation by the scale factor (X) to generate the head-translation.

12. (canceled)

13. A head-mounted device comprising:
a stereoscopic display configured to display stereoscopic images;
a memory configured to store a parameters associated with a head-worn device; and
a processor coupled to the stereoscopic display and the memory, the processor configured by software instructions to:
provide the parameters to a first application running on the processor, the first application configured to render a scene at a first stereoscopic depth based on the parameter; and
adjust the parameter provided to the first application to modify the first stereoscopic depth of the scene to an adjusted stereoscopic depth while a second application, running on the processor, renders a window at a second stereoscopic depth based on the parameter, the window overlapping the scene on the stereoscopic display.

14. The head-mounted device according to claim 13, wherein the second stereoscopic depth is less than the adjusted stereoscopic depth to prevent the window overlapping the scene on the stereoscopic display from creating a depth conflict for a user.

15. The head-mounted device according to claim 13, wherein the parameter is an interpupillary distance.

16. The head-mounted device according to claim 15, wherein the interpupillary distance is reduced to an adjusted interpupillary distance to increase the first stereoscopic depth of the scene to the adjusted stereoscopic depth.

17. The head-mounted device according to claim 16, wherein the interpupillary distance is reduced to the adjusted interpupillary distance over a period.

18. The head-mounted device according to claim 16, wherein the adjusted interpupillary distance is zero and the adjusted stereoscopic depth is infinity.

19. The head-mounted device according to claim 13, wherein the parameter is a head-translation.

20. The head-mounted device according to claim 19, wherein the head-translation is reduced to an adjusted head translation to decrease a motion-parallax of the scene.

21. The head-mounted device according to claim 13, wherein the head-mounted device is a virtual reality system.

22-32. (canceled)

33. The method according to claim 1, further comprising:
preventing an overlap of the second stereoscopic images on the first stereoscopic images from creating a depth conflict based on the second stereoscopic depth being less than the first stereoscopic depth.
